(19) United States
(12) Patent Application Publication
(10) Pub. No.: US 2014/0032881 A1
(43) Pub. Date: Jan. 30, 2014

(54) INSTRUCTION AND LOGIC FOR PERFORMING A DOT-PRODUCT OPERATION

(71) Applicants: Ronen Zohar, Sunnyvale, CA (US); Mark Seconi, Beaverton, OR (US); Rajesh Parthasarathy, Hillsboro, OR (US); Srinivas Chennupaty, Portland, OR (US); Mark Buxton, Chandler, AZ (US); Chuck Desylva, Fair Oaks, CA (US)

(72) Inventors: Ronen Zohar, Sunnyvale, CA (US); Mark Seconi, Beaverton, OR (US); Rajesh Parthasarathy, Hillsboro, OR (US); Srinivas Chennupaty, Portland, OR (US); Mark Buxton, Chandler, AZ (US); Chuck Desylva, Fair Oaks, CA (US)

(21) Appl. No.: 14/042,696

(22) Filed: Sep. 30, 2013

Related U.S. Application Data
(63) Continuation of application No. 13/844,366, filed on Mar. 15, 2013.
Application No. 13/844,366 is a continuation of application No. 11/524,852, filed on Sep. 20, 2006.

(51) Int. Cl. G06F 9/30

(52) U.S. Cl. CPC G06F 9/3001
USPC 712/207

(57) ABSTRACT

Method, apparatus, and program means for performing a dot-product operation. In one embodiment, an apparatus includes execution resources to execute a first instruction. In response to the first instruction, said execution resources store to a storage location a result value equal to a dot-product of at least two operands.

### RELATED APPLICATIONS

This is a Continuation of application Ser. No. 13/844,366, filed Mar. 15, 2013, currently pending, which is a Continuation of application Ser. No. 11/524,852, filed Sep. 20, 2006, currently pending.

### FIELD OF THE INVENTION

The present disclosure pertains to the field of processing apparatuses and associated software and software sequences that perform mathematical operations.

### DESCRIPTION OF RELATED ART

Computer systems have become increasingly pervasive in our society. The processing capabilities of computers have increased the efficiency and productivity of workers in a wide spectrum of professions. As the costs of purchasing and owning a computer continues to drop, more and more consumers have been able to take advantage of newer and faster machines. Furthermore, many people enjoy the use of notebook computers because of the freedom. Mobile computers allow users to easily transport their data and work with them as they leave the office or travel. This scenario is quite familiar with marketing staff, corporate executives, and even students.

As processor technology advances, newer software code is also being generated to run on machines with these processors. Users generally expect and demand higher performance from their computers regardless of the type of software being used. One such issue can arise from the kinds of instructions and operations that are actually being performed within the processor. Certain types of operations require more time to complete based on the complexity of the operations and/or type of circuitry needed. This provides an opportunity to optimize the way certain complex operations are executed inside the processor.

Media applications have been driving microprocessor development for more than a decade. In fact, most computing upgrades in recent years have been driven by media applications. These upgrades have predominantly occurred within consumer segments, although significant advances have also been seen in enterprise segments for entertainment enhanced education and communication purposes. Nevertheless, future media applications will require even higher computational requirements. As a result, tomorrow's personal computing experience will be even richer in audio-visual effects, as well as being easier to use, and more importantly, computing will merge with communications.

Accordingly, the display of images, as well as playback of audio and video data, which is collectively referred to as content, have become increasingly popular applications for current computing devices. Filtering and convolution operations are some of the most common operations performed on content data, such as image audio and video data. Such operations are computationally intensive, but offer a high level of data parallelism that can be exploited through an efficient implementation using various data storage devices, such as for example, single instruction multiple data (SIMD) registers. A number of current architectures also require multiple operations, instructions, or sub-instructions (often referred to as “micro-operations” or “uops”) to perform various mathematical operations on a number of operands, thereby diminishing throughput and increasing the number of clock cycles required to perform the mathematical operations.

For example, an instruction sequence consisting of a number of instructions may be required to perform one or more operations necessary to generate a dot-product, including adding the products of two or more numbers represented by various datatypes within a processing apparatus, system or computer program. However, such prior art techniques may require numerous processing cycles and may cause a processor or system to consume unnecessary power in order to generate the dot-product. Furthermore, some prior art techniques may be limited in the operand datatypes that may be operated upon.

### BRIEF DESCRIPTION OF THE FIGURES

The present invention is illustrated by way of example and not limitation in the Figures of the accompanying drawings:

FIG. 1A is a block diagram of a computer system formed with a processor that includes execution units to execute an instruction for a dot-product operation in accordance with one embodiment of the present invention;

FIG. 1B is a block diagram of another exemplary computer system in accordance with an alternative embodiment of the present invention;

FIG. 1C is a block diagram of yet another exemplary computer system in accordance with another alternative embodiment of the present invention;

FIG. 2 is a block diagram of the micro-architecture for a processor of one embodiment that includes logic circuits to perform a dot-product operation in accordance with the present invention;

FIG. 3A illustrates various packed data type representations in multimedia registers according to one embodiment of the present invention;

FIG. 3B illustrates packed data-types in accordance with an alternative embodiment;

FIG. 3C illustrates various signed and unsigned packed data type representations in multimedia registers according to one embodiment of the present invention;

FIG. 3D illustrates one embodiment of an operation encoding (opcode) format;

FIG. 3E illustrates an alternative operation encoding (opcode) format;

FIG. 3F illustrates yet another alternative operation encoding format;

FIG. 4 is a block diagram of one embodiment of logic to perform a dot-product operation on packed data operands in accordance with the present invention.

FIG. 5a is a block diagram of a logic to perform a dot-product operation on single precision packed data operands in accordance with one embodiment of the present invention;

FIG. 5b is a block diagram of logic to perform a dot-product operation on double precision packed data operands in accordance with one embodiment of the present invention;

FIG. 6A is a block diagram of a circuit for performing a dot-product operation in accordance with one embodiment of the present invention;

FIG. 6B is a block diagram of a circuit for performing a dot-product operation in accordance with another embodiment of the present invention;

FIG. 7 is a block diagram of one embodiment of logic to perform a packed sign operation on packed data operands. FIG. 7A is a pseudo-code representation of operations that may be performed by executing a DPPS instruction, according to one embodiment.

FIG. 7B is a pseudo-code representation of operations that may be performed by executing a DPPD instruction, according to one embodiment.

### DETAILED DESCRIPTION

The following description describes embodiments of a technique to perform a dot-product operation within a processing apparatus, computer system, or software program. In the following description, numerous specific details such as processor types, micro-architectural conditions, events, enablement mechanisms, and the like are set forth in order to provide a more thorough understanding of the present invention. It will be appreciated, however, by one skilled in the art that the invention may be practiced without such specific details. Additionally, some well known structures, circuits, and the like have not been shown in detail to avoid unnecessarily obscuring the present invention.

Although the following embodiments are described with reference to a processor, other embodiments are applicable to other types of integrated circuits and logic devices. The same techniques and teachings of the present invention can easily be applied to other types of circuits or semiconductor devices that can benefit from higher pipeline throughput and improved performance. The teachings of the present invention are applicable to any processor or machine that performs data manipulations. However, the present invention is not limited to processors or machines that perform 256 bit, 128 bit, 64 bit, 32 bit, or 16 bit data operations and can be applied to any processor and machine in which manipulation of packed data is needed.

In the following description, for purposes of explanation, numerous specific details are set forth in order to provide a thorough understanding of the present invention. One of ordinary skill in the art, however, will appreciate that these specific details are not necessary in order to practice the present invention. In other instances, well known electrical structures and circuits have not been set forth in particular detail in order to not necessarily obscure the present invention. In addition, the following description provides examples, and the accompanying drawings show various examples for the purposes of illustration. However, these examples should not be construed in a limiting sense as they are merely intended to provide examples of the present invention rather than to provide an exhaustive list of all possible implementations of the present invention.

Although the below examples describe instruction handling and distribution in the context of execution units and logic circuits, other embodiments of the present invention can be accomplished by way of software. In one embodiment, the methods of the present invention are embodied in machine-executable instructions. The instructions can be used to cause a general-purpose or special-purpose processor that is programmed with the instructions to perform the steps of the present invention. The present invention may be provided as a computer program product or software which may include a machine or computer-readable medium having stored thereon instructions which may be used to program a computer (or other electronic devices) to perform a process according to the present invention. Alternatively, the steps of the present invention might be performed by specific hardware components that contain hardwired logic for performing the steps, or by any combination of programmed computer components and custom hardware components. Such software can be stored within a memory in the system. Similarly, the code can be distributed via a network or by way of other computer readable media.

Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like. Accordingly, the computer-readable medium includes any type of media/machine-readable medium suitable for storing or transmitting electronic instructions or information in a form readable by a machine (e.g., a computer). Moreover, the present invention may also be downloaded as a computer program product. As such, the program may be transferred from a remote computer (e.g., a server) to a requesting computer (e.g., a client). The transfer of the program may be by way of electrical, optical, acoustical, or other forms of data signals embodied in a carrier wave or other propagation medium via a communication link (e.g., a modem, network connection or the like).

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) embodying techniques of the present invention.

In modern processors, a number of different execution units are used to process and execute a variety of code and instructions. Not all instructions are created equal as some are quicker to complete while others can take an enormous number of clock cycles. The faster the throughput of instructions, the better the overall performance of the processor. Thus it would be advantageous to have as many instructions execute as fast as possible. However, there are certain instructions that have greater complexity and require more in terms of execution time and processor resources. For example, there are floating point instructions, load/store operations, data moves, etc.

As more and more computer systems are used in internet and multimedia applications, additional processor support has been introduced over time. For instance, Single Instruction, Multiple Data (SIMD) integer/floating point instructions and Streaming SIMD Extensions (SSE) are instructions that reduce the overall number of instructions required to execute a particular program task, which in turn can reduce the power consumption. These instructions can speed up software performance by operating on multiple data elements in parallel. As a result, performance gains can be achieved in a wide range of applications including video, speech, and image/photo processing. The implementation of SIMD instructions in microprocessors and similar types of logic circuit usually involve a number of issues. Furthermore, the complexity of SIMD operations often leads to a need for additional circuitry in order to correctly process and manipulate the data.

Presently a SIMD dot-product instruction is not available. Without the presence of a SIMD dot-product instruction, a large number of instructions and data registers may be needed to accomplish the same results in applications such as audio/video compression, processing, and manipulation. Thus, at least one dot-product instruction in accordance with embodiments of the present invention can reduce code overhead and resource requirements. Embodiments of the present invention provide a way to implement a dot-product operation as an algorithm that makes use of SIMD related hardware. Presently, it is somewhat difficult and tedious to perform dot-product operations on data in a SIMD register. Some algorithms require more instructions to arrange data for arithmetic operations than the actual number of instructions to execute those operations. By implementing embodiments of a dot-product operation in accordance with embodiments of the present invention, the number of instructions needed to achieve dot-product processing can be drastically reduced.

Embodiments of the present invention involve an instruction for implementing a dot-product operation. A dot-product operation generally involves multiplying at least two values and adding this product to the product of at least two other values. Other variations may be made on the generic dot-product algorithm, including adding the result of various dot-product operations to generate another dot-product. For example, a dot product operation according to one embodiment as applied to data elements can be generically represented as:

DEST1←SRC1*SRC2;

DEST2←SRC3*SRC4;

DEST3←DEST1+DEST2;

For a packed SIMD data operand, this flow can be applied to each data element of each operand.

In the above flow, “DEST” and “SRC” are generic terms to represent the source and destination of the corresponding data or operation. In some embodiments, they may be implemented by registers, memory, or other storage areas having other names or functions than those depicted. For example, in one embodiment, DEST1 and DEST2 may be a first and second temporary storage area (e.g., “TEMP1” and “TEMP2” register), SRC1 and SRC3 may be first and second destination storage area (e.g., “DEST1” and “DEST2” register), and so forth. In other embodiments, two or more of the SRC and DEST storage areas may correspond to different data storage elements within the same storage area (e.g., a SIMD register). Furthermore, in one embodiment, a dot-product operation may generate sum of dot-products generated by the above generic flow.

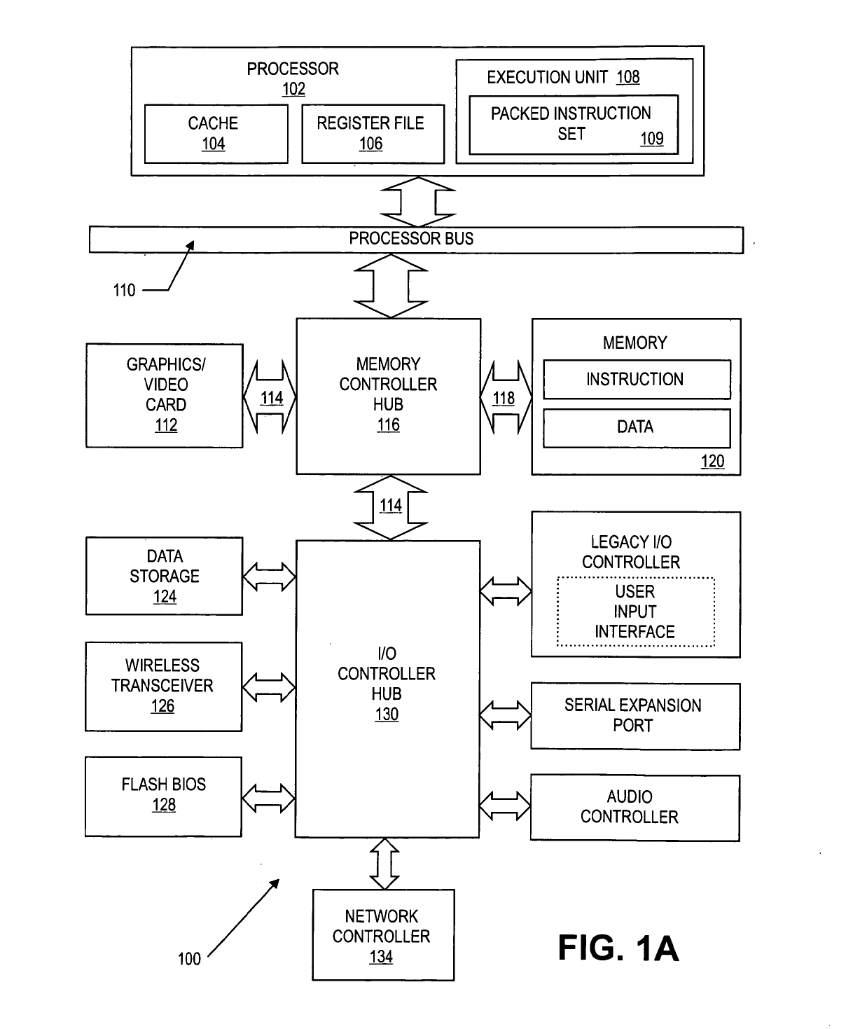

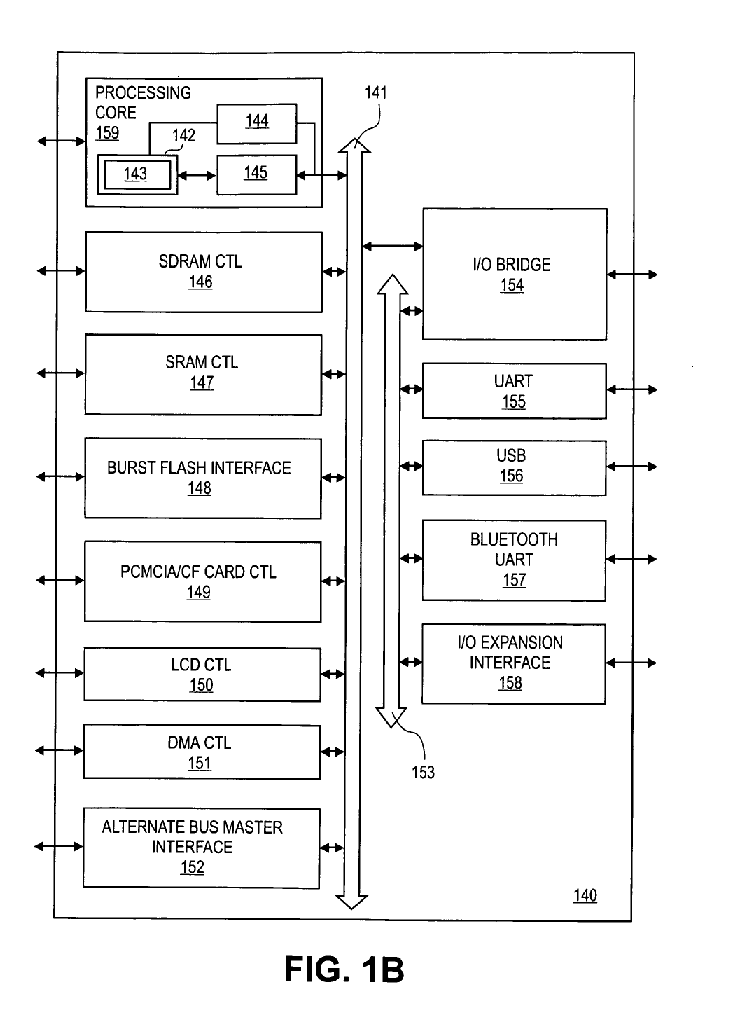

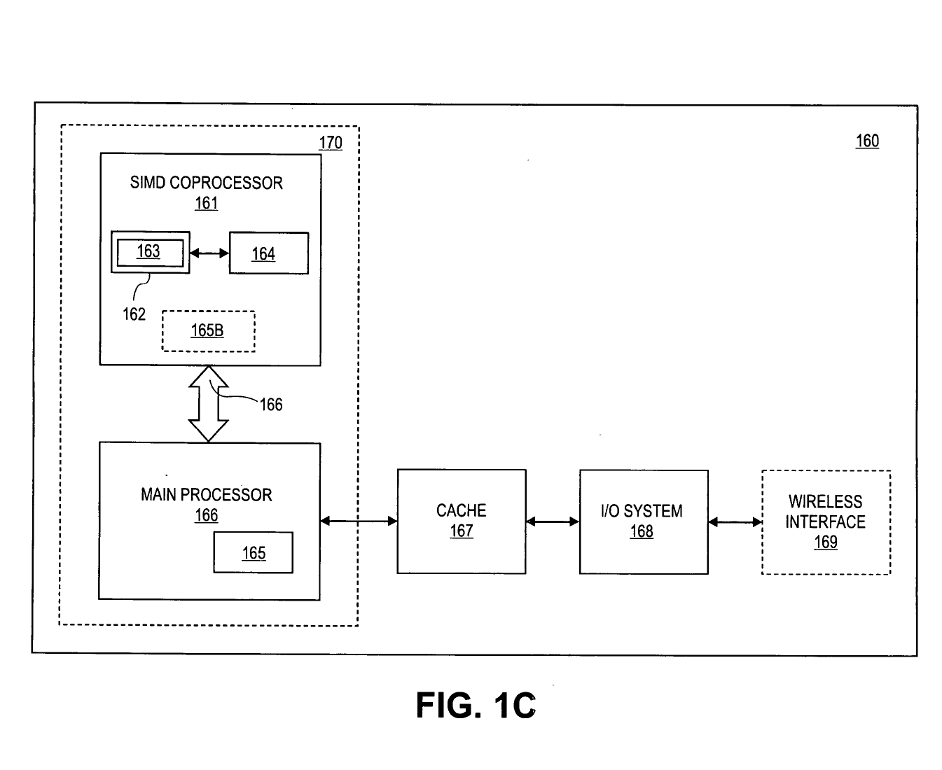

FIG. 1A is a block diagram of an exemplary computer system formed with a processor that includes execution units to execute an instruction for a dot-product operation in accordance with one embodiment of the present invention. System 100 includes a component, such as a processor 102 to employ execution units including logic to perform algorithms for process data, in accordance with the present invention, such as in the embodiment described herein. System 100 is representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 100 may execute a version of the WINDOWS™ operating system available from Microsoft Corporation of Redmond, Wash., although other operating systems (UNIX and Linux for example), embedded software, and/or graphical user interfaces, may also be used. Thus, embodiments of the present invention is not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that performs dot-product operations on operands. Furthermore, some architectures have been implemented to enable instructions to operate on several data simultaneously to improve the efficiency of multimedia applications. As the type and volume of data increases, computers and their processors have to be enhanced to manipulate data in more efficient methods.

FIG. 1A is a block diagram of a computer system 100 formed with a processor 102 that includes one or more execution units 108 to perform an algorithm to calculate the dot-product of a data elements from one or more operands in accordance with one embodiment of the present invention. One embodiment may be described in the context of a single processor desktop or server system, but alternative embodiments can be included in a multiprocessor system. System 100 is an example of a hub architecture. The computer system 100 includes a processor 102 to process data signals. The processor 102 can be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102 is coupled to a processor bus 110 that can transmit data signals between the processor 102 and other components in the system 100. The elements of system 100 perform their conventional functions that are well known to those familiar with the art.

In one embodiment, the processor 102 includes a Level 1 (L1) internal cache memory 104. Depending on the architecture, the processor 102 can have a single internal cache or multiple levels of internal cache. Alternatively, in another embodiment, the cache memory can reside external to the processor 102. Other embodiments can also include a combination of both internal and external caches depending on the particular implementation and needs. Register file 106 can store different types of data in various registers including integer registers, floating point registers, status registers, and instruction pointer register.

Execution unit 108, including logic to perform integer and floating point operations, also resides in the processor 102. The processor 102 also includes a microcode (ucode) ROM that stores microcode for certain macroinstructions. For this embodiment, execution unit 108 includes logic to handle a packed instruction set 109. In one embodiment, the packed instruction set 109 includes a packed dot-product instruction for calculating the dot-product of a number of operands. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications can be accelerated and executed more efficiently by using the full width of a processor's data bus for performing operations on packed data. This can eliminate the need to transfer smaller units of data across the processor's data bus to perform one or more operations one data element at a time.

Alternate embodiments of an execution unit 108 can also be used in micro controllers, embedded processors, graphics devices, DSPs, and other types of logic circuits. System 100 includes a memory 120. Memory 120 can be a dynamic random access memory (DRAM) device, a static random access memory (SRAM) device, flash memory device, or other memory device. Memory 120 can store instructions and/or data represented by data signals that can be executed by the processor 102.

A system logic chip 116 is coupled to the processor bus 110 and memory 120. The system logic chip 116 in the illustrated embodiment is a memory controller hub (MCH). The processor 102 can communicate to the MCH 116 via a processor bus 110. The MCH 116 provides a high bandwidth memory path 118 to memory 120 for instruction and data storage and for storage of graphics commands, data and textures. The MCH 116 is to direct data signals between the processor 102, memory 120, and other components in the system 100 and to bridge the data signals between processor bus 110, memory 120, and system I/O 122. In some embodiments, the system logic chip 116 can provide a graphics port for coupling to a graphics controller 112. The MCH 116 is coupled to memory 120 through a memory interface 118. The graphics card 112 is coupled to the MCH 116-through an Accelerated Graphics Port (AGP) interconnect 114.

System 100 uses a proprietary hub interface bus 122 to couple the MCH 116 to the I/O controller hub (ICH) 130. The ICH 130 provides direct connections to some I/O devices via a local I/O bus. The local I/O bus is a high-speed I/O bus for connecting peripherals to the memory 120, chipset, and processor 102. Some examples are the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. The data storage device 124 can comprise a hard disk drive, a floppy disk drive, a CD-ROM device, a flash memory device, or other mass storage device.

For another embodiment of a system, an execution unit to execute an algorithm with a dot-product instruction can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

FIG. 1B illustrates a data processing system 140 which implements the principles of one embodiment of the present invention. It will be readily appreciated by one of skill in the art that the embodiments described herein can be used with alternative processing systems without departure from the scope of the invention.

Computer system 140 comprises a processing core 159 capable of performing SIMD operations including a dot-product operation. For one embodiment, processing core 159 represents a processing unit of any type of architecture, including but not limited to a CISC, a RISC or a VLIW type architecture. Processing core 159 may also be suitable for manufacture in one or more process technologies and by being represented on a machine readable media in sufficient detail, may be suitable to facilitate said manufacture.

Processing core 159 comprises an execution unit 142, a set of register file(s) 145, and a decoder 144. Processing core 159 also includes additional circuitry (not shown) which is not necessary to the understanding of the present invention. Execution unit 142 is used for executing instructions received by processing core 159. In addition to recognizing typical processor instructions, execution unit 142 can recognize instructions in packed instruction set 143 for performing operations on packed data formats. Packed instruction set 143 includes instructions for supporting dot-product operations, and may also include other packed instructions. Execution unit 142 is coupled to register file 145 by an internal bus. Register file 145 represents a storage area on processing core 159 for storing information, including data. As previously mentioned, it is understood that the storage area used for storing the packed data is not critical. Execution unit 142 is coupled to decoder 144. Decoder 144 is used for decoding instructions received by processing core 159 into control signals and/or microcode entry points. In response to these control signals and/or microcode entry points, execution unit 142 performs the appropriate operations.

Processing core 159 is coupled with bus 141 for communicating with various other system devices, which may include but are not limited to, for example, synchronous dynamic random access memory (SDRAM) control 146, static random access memory (SRAM) control 147, burst flash memory interface 148, personal computer memory card international association (PCMCIA)/compact flash (CF) card control 149, liquid crystal display (LCD) control 150, direct memory access (DMA) controller 151, and alternative bus master interface 152. In one embodiment, data processing system 140 may also comprise an I/O bridge 154 for communicating with various I/O devices via an I/O bus 153. Such I/O devices may include but are not limited to, for example, universal asynchronous receiver/transmitter (UART) 155, universal serial bus (USB) 156, Bluetooth wireless UART 157 and I/O expansion interface 158.

One embodiment of data processing system 140 provides for mobile, network and/or wireless communications and a processing core 159 capable of performing SIMD operations including a dot-product operation. Processing core 159 may be programmed with various audio, video, imaging and communications algorithms including discrete transformations such as a Walsh-Hadamard transform, a fast Fourier transform (FFT), a discrete cosine transform (DCT), and their respective inverse transforms; compression/decompression techniques such as color space transformation, video encode motion estimation or video decode motion compensation; and modulation/demodulation (MODEM) functions such as pulse coded modulation (PCM). Some embodiments of the invention may also be applied to graphics applications, such as three dimensional (“3D”) modeling, rendering, objects collision detection, 3D objects transformation and lighting, etc.

FIG. 1C illustrates yet alternative embodiments of a data processing system capable of performing SIMD dot-product operations. In accordance with one alternative embodiment, data processing system 160 may include a main processor 166, a SIMD coprocessor 161, a cache memory 167, and an input/output system 168. The input/output system 168 may optionally be coupled to a wireless interface 169. SIMD coprocessor 161 is capable of performing SIMD operations including dot-product operations. Processing core 170 may be suitable for manufacture in one or more process technologies and by being represented on a machine readable media in sufficient detail, may be suitable to facilitate the manufacture of all or part of data processing system 160 including processing core 170.

For one embodiment, SIMD coprocessor 161 comprises an execution unit 162 and a set of register file(s) 164. One embodiment of main processor 165 comprises a decoder 165 to recognize instructions of instruction set 163 including SIMD dot-product calculation instructions for execution by execution unit 162. For alternative embodiments, SIMD coprocessor 161 also comprises at least part of decoder 165B to decode instructions of instruction set 163. Processing core 170 also includes additional circuitry (not shown) which is not necessary to the understanding of embodiments of the present invention.

In operation, the main processor 166 executes a stream of data processing instructions that control data processing operations of a general type including interactions with the cache memory 167, and the input/output system 168. Embedded within the stream of data processing instructions are SIMD coprocessor instructions. The decoder 165 of main processor 166 recognizes these SIMD coprocessor instructions as being of a type that should be executed by an attached SIMD coprocessor 161. Accordingly, the main processor 166 issues these SIMD coprocessor instructions (or control signals representing SIMD coprocessor instructions) on the coprocessor bus 166 where from they are received by any attached SIMD coprocessors. In this case, the SIMD coprocessor 161 will accept and execute any received SIMD coprocessor instructions intended for it.

Data may be received via wireless interface 169 for processing by the SIMD coprocessor instructions. For one example, voice communication may be received in the form of a digital signal, which may be processed by the SIMD coprocessor instructions to regenerate digital audio samples representative of the voice communications. For another example, compressed audio and/or video may be received in the form of a digital bit stream, which may be processed by the SIMD coprocessor instructions to regenerate digital audio samples and/or motion video frames. For one embodiment of processing core 170, main processor 166, and a SIMD coprocessor 161 are integrated into a single processing core 170 comprising an execution unit 162, a set of register file(s) 164, and a decoder 165 to recognize instructions of instruction set 163 including SIMD dot-product instructions.

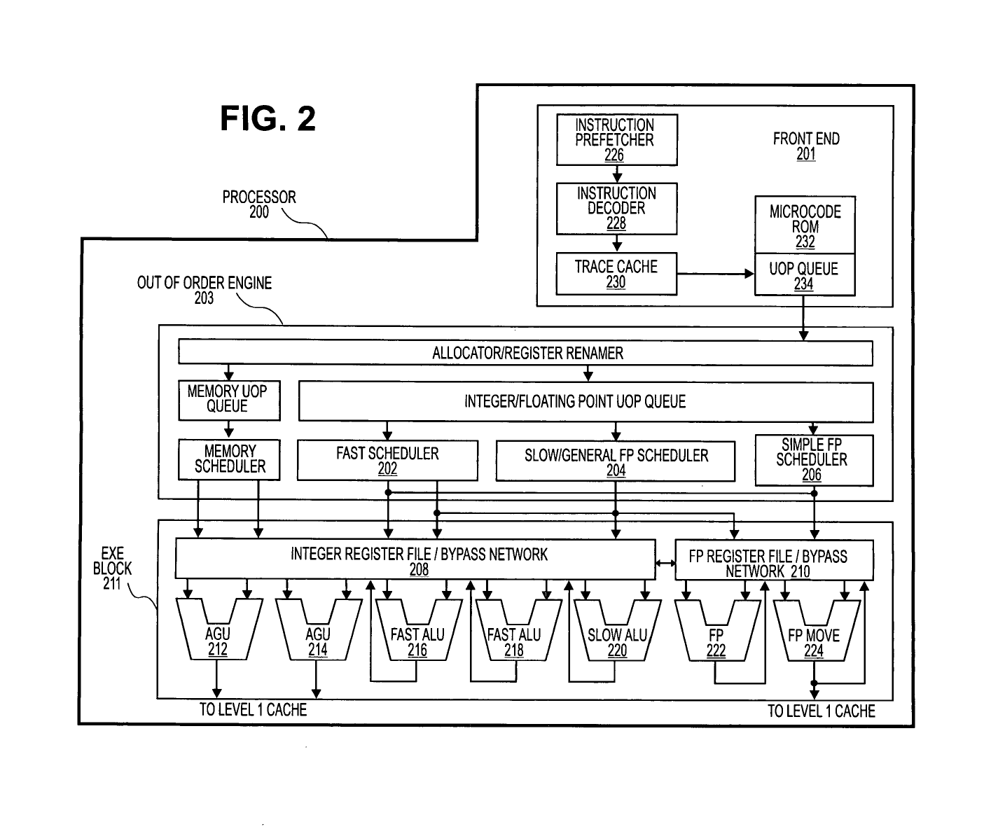

FIG. 2 is a block diagram of the micro-architecture for a processor 200 that includes logic circuits to perform a dot-product instruction in accordance with one embodiment of the present invention. For one embodiment of the dot-product instruction, the instruction can multiply a first data element with a second data element and add this product to a product of third and fourth data element. In some embodiments, the dot-product instruction can be implemented to operate on data elements having sizes of byte, word, doubleword, quadword, etc., as well as datatypes, such as single and double precision integer and floating point datatypes. In one embodiment the in-order front end 201 is the part of the processor 200 that fetches macro-instructions to be executed and prepares them to be used later in the processor pipeline. The front end 201 may include several units. In one embodiment, the instruction prefetcher 226 fetches macro-instructions from memory and feeds them to an instruction decoder 228 which in turn decodes them into primitives called micro-instructions or micro-operations (also called micro op or uops) that the machine can execute. In one embodiment, the trace cache 230 takes decoded uops and assembles them into program ordered sequences or traces in the uop queue 234 for execution. When the trace cache 230 encounters a complex macro-instruction, the microcode ROM 232 provides the uops needed to complete the operation.

Many macro-instructions are converted into a single micro-op, whereas others need several micro-ops to complete the full operation. In one embodiment, if more than four micro-ops are needed to complete a macro-instruction, the decoder 228 accesses the microcode ROM 232 to do the macro-instruction. For one embodiment, a packed dot-product instruction can be decoded into a small number of micro ops for processing at the instruction decoder 228. In another embodiment, an instruction for a packed dot-product algorithm can be stored within the microcode ROM 232 should a number of micro-ops be needed to accomplish the operation. The trace cache 230 refers to a entry point programmable logic array (PLA) to determine a correct micro-instruction pointer for reading the micro-code sequences for the dot-product algorithm in the micro-code ROM 232. After the microcode ROM 232 finishes sequencing micro-ops for the current macro-instruction, the front end 201 of the machine resumes fetching micro-ops from the trace cache 230.

Some SIMD and other multimedia types of instructions are considered complex instructions. Most floating point related instructions are also complex instructions. As such, when the instruction decoder 228 encounters a complex macro-instruction, the microcode ROM 232 is accessed at the appropriate location to retrieve the microcode sequence for that macro-instruction. The various micro-ops needed for performing that macro-instruction are communicated to the out-of-order execution engine 203 for execution at the appropriate integer and floating point execution units.

The out-of-order execution engine 203 is where the micro-instructions are prepared for execution. The out-of-order execution logic has a number of buffers to smooth out and re-order the flow of micro-instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 202, slow/general floating point scheduler 204, and simple floating point scheduler 206. The uop schedulers 202, 204, 206, determine when a uop is ready to execute based on the readiness of their dependent input register operand sources and the availability of the execution resources the uops need to complete their operation. The fast scheduler 202 of this embodiment can schedule on each half of the main clock cycle while the other schedulers can only schedule once per main processor clock cycle. The schedulers arbitrate for the dispatch ports to schedule uops for execution.

Register files 208, 210, sit between the schedulers 202, 204, 206, and the execution units 212, 214, 216, 218, 220, 222, 224 in the execution block 211. There is a separate register file 208, 210, for integer and floating point operations, respectively. Each register file 208, 210, of this embodiment also includes a bypass network that can bypass or forward just completed results that have not yet been written into the register file to new dependent uops. The integer register file 208 and the floating point register file 210 are also capable of communicating data with the other. For one embodiment, the integer register file 208 is split into two separate register files, one register file for the low order 32 bits of data and a second register file for the high order 32 bits of data. The floating point register file 210 of one embodiment has 128 bit wide entries because floating point instructions typically have operands from 64 to 128 bits in width.

The execution block 211 contains the execution units 212, 214, 216, 218, 220, 222, 224, where the instructions are actually executed. This section includes the register files 208, 210, that store the integer and floating point data operand values that the micro-instructions need to execute. The processor 200 of this embodiment is comprised of a number of execution units: address generation unit (AGU) 212, AGU 214, fast ALU 216, fast ALU 218, slow ALU 220, floating point ALU 222, floating point move unit 224. For this embodiment, the floating point execution blocks 222, 224, execute floating point, MMX, SIMD, and SSE operations. The floating point ALU 222 of this embodiment includes a 64 bit by 64 bit floating point divider to execute divide, square root, and remainder micro-ops. For embodiments of the present invention, any act involving a floating point value occurs with the floating point hardware. For example, conversions between integer format and floating point format involve a floating point register file. Similarly, a floating point divide operation happens at a floating point divider. On the other hand, non-floating point numbers and integer type are handled with integer hardware resources. The simple, very frequent ALU operations go to the high-speed ALU execution units 216, 218. The fast ALUs 216, 218, of this embodiment can execute fast operations with an effective latency of half a clock cycle. For one embodiment, most complex integer operations go to the slow ALU 220 as the slow ALU 220 includes integer execution hardware for long latency type of operations, such as a multiplier, shifts, flag logic, and branch processing. Memory load/store operations are executed by the AGUs 212, 214. For this embodiment, the integer ALUs 216, 218, 220, are described in the context of performing integer operations on 64 bit data operands. In alternative embodiments, the ALUs 216, 218, 220, can be implemented to support a variety of data bits including 16, 32, 128, 256, etc. Similarly, the floating point units 222, 224, can be implemented to support a range of operands having bits of various widths. For one embodiment, the floating point units 222, 224, can operate on 128 bits wide packed data operands in conjunction with SIMD and multimedia instructions.

In this embodiment, the uops schedulers 202, 204, 206, dispatch dependent operations before the parent load has finished executing. As uops are speculatively scheduled and executed in processor 200, the processor 200 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for dot-product operations.

The term “registers” is used herein to refer to the on-board processor storage locations that are used as part of macro-instructions to identify operands. In other words, the registers referred to herein are those that are visible from the outside of the processor (from a programmer's perspective). However, the registers of an embodiment should not be limited in meaning to a particular type of circuit. Rather, a register of an embodiment need only be capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains sixteen XMM and general purpose registers, eight multimedia (e.g., “EM64T” additions) multimedia SIMD registers for packed data. For the discussions below, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In this embodiment, in storing packed data and integer data, the registers do not need to differentiate between the two data types.

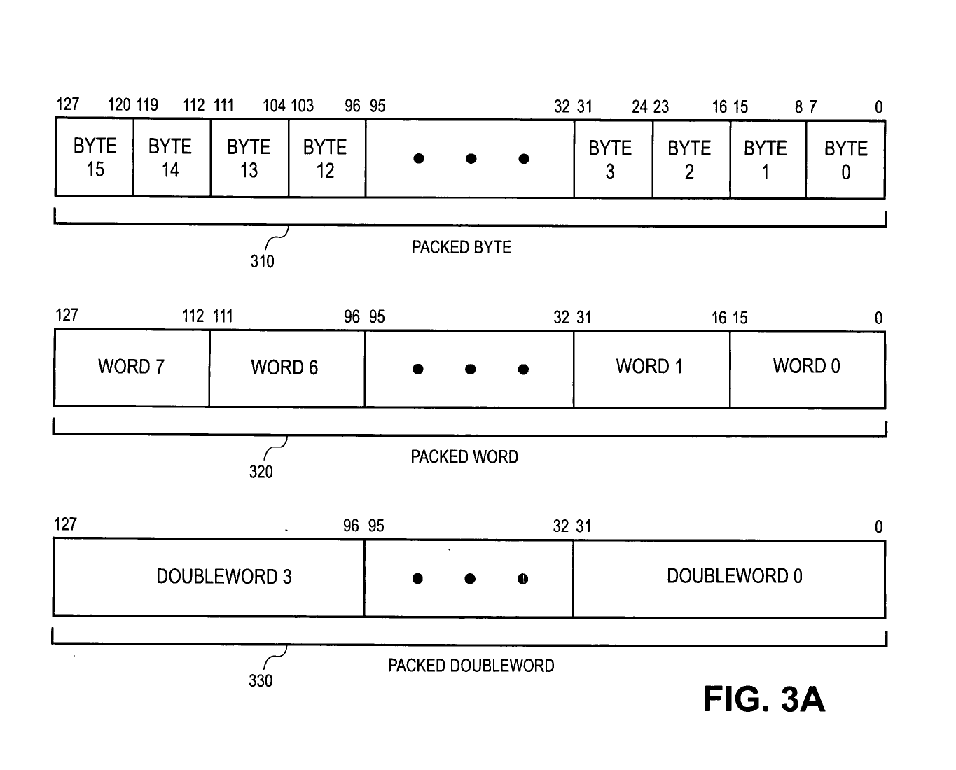

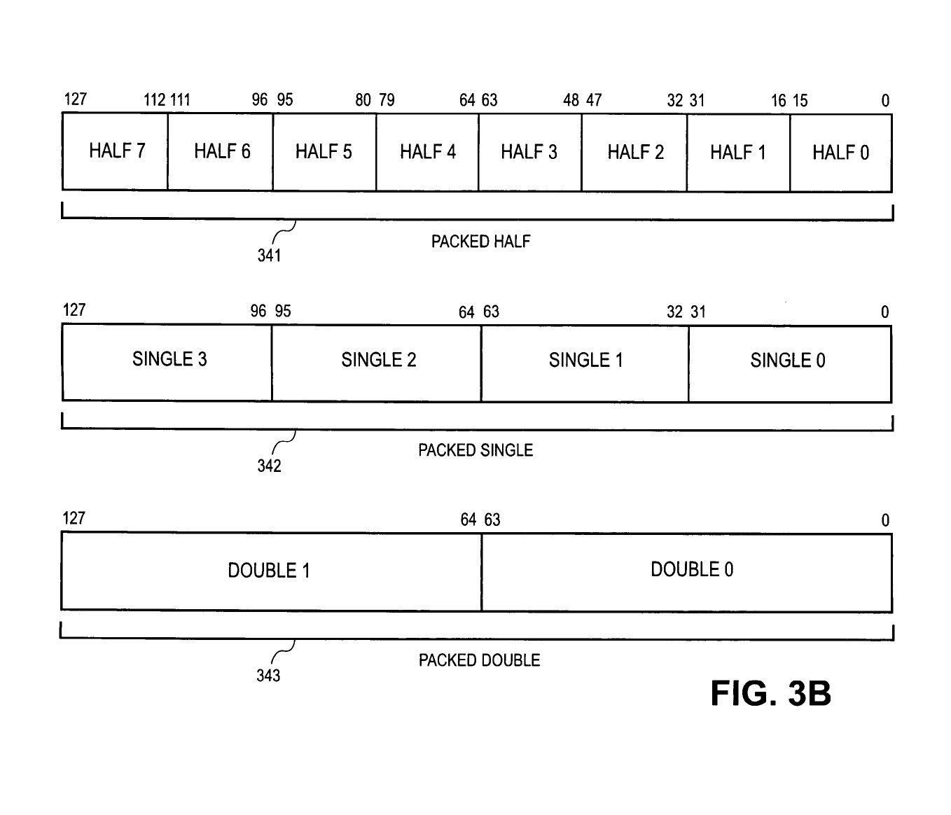

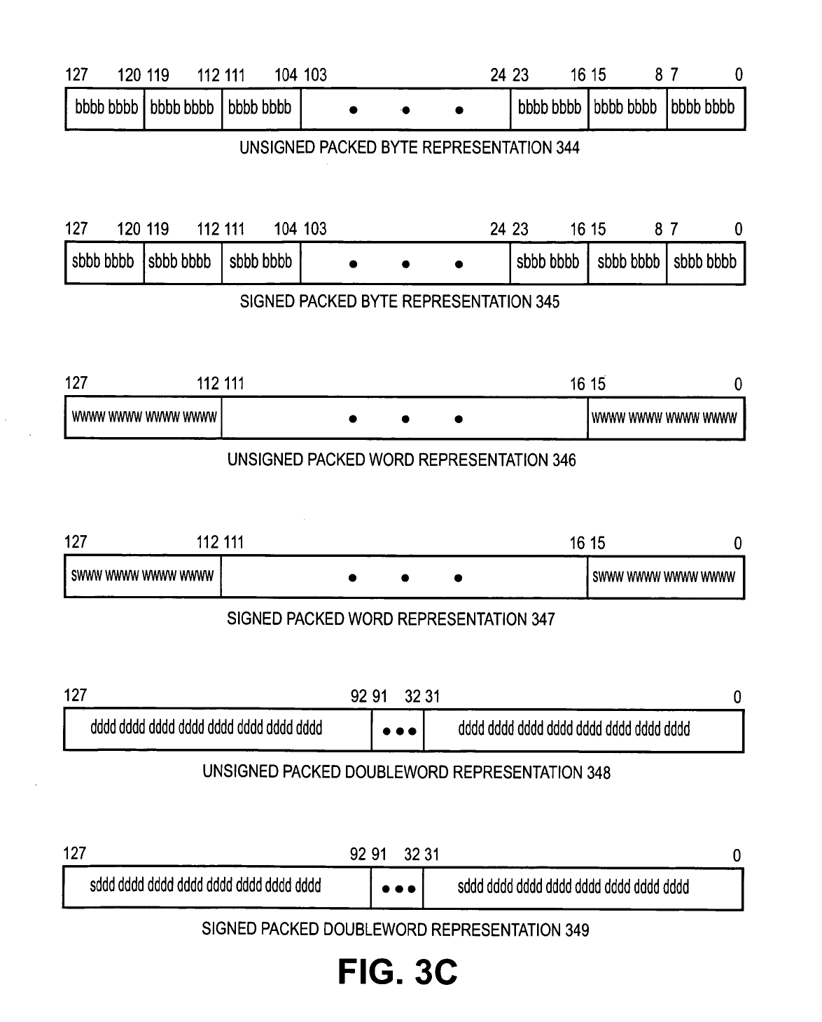

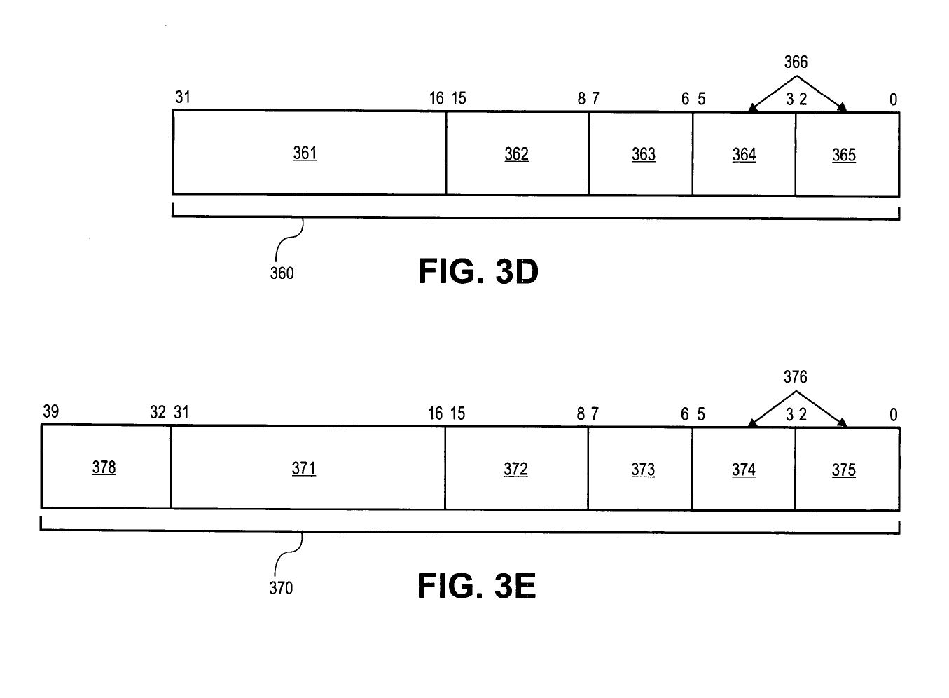

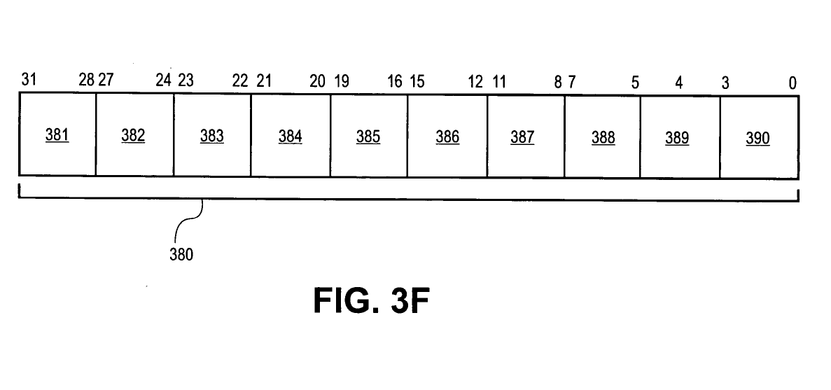

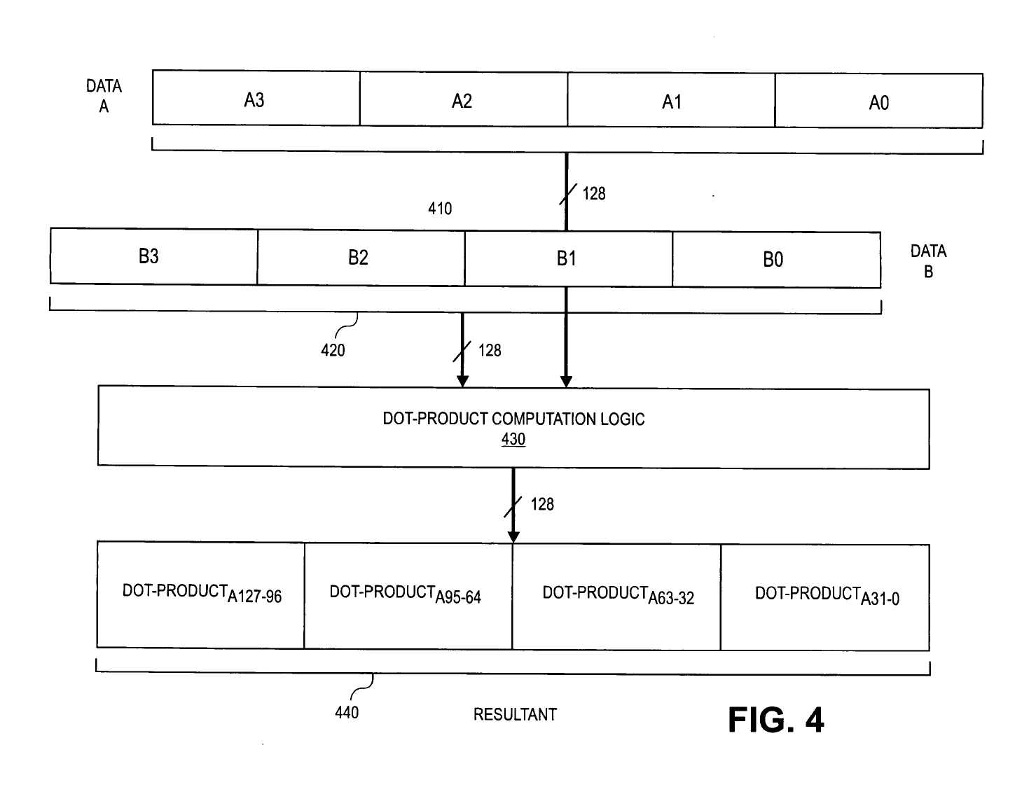

In the examples of the following figures, a number of data operands are described. FIG. 3A illustrates various packed data type representations in multimedia registers according to one embodiment of the present invention. FIG. 3A illustrates data types for a packed byte 310, a packed word 320, and a packed doubleword (dword) 330 for 128 bits wide operands. The packed byte format 310 of this example is 128 bits long and contains sixteen packed byte data elements. A byte is defined here as 8 bits of data. Information for each byte data element is stored in bit 7 through bit 0 for byte 0, bit 15 through bit 8 for byte 1, bit 23 through bit 16 for byte 2, and finally bit 120 through bit 127 for byte 15. Thus, all available bits are used in the register. This storage arrangement increases the storage efficiency of the processor. As well, with sixteen data elements accessed, one operation can now be performed on sixteen data elements in parallel.

Generally, a data element is an individual piece of data that is stored in a single register or memory location with other data elements of the same length. In packed data sequences relating to SSEx technology, the number of data elements stored in a XMM register is 128 bits divided by the length in bits of an individual data element. Similarly, in packed data sequences relating to MMX and SSE technology, the number of data elements stored in an MMX register is 64 bits divided by the length in bits of an individual data element. Although the data types illustrated in FIG. 3A are 128 bit long, embodiments of the present invention can also operate with 64 bit wide or other sized operands. The packed word format 320 of this example is 128 bits long and contains eight packed word data elements. Each packed word contains sixteen bits of information. The packed doubleword format 330 of FIG. 3A is 128 bits long and contains four packed doubleword data elements. Each packed doubleword data element contains thirty two bits of information. A packed quadword is 128 bits long and contains two packed quad-word data elements.

FIG. 3B illustrates alternative in-register data storage formats. Each packed data can include more than one independent data element. Three packed data formats are illustrated; packed half 341, packed single 342, and packed double 343. One embodiment of packed half 341, packed single 342, and packed double 343 contain fixed-point data elements. For an alternative embodiment one or more of packed half 341, packed single 342, and packed double 343 may contain floating-point data elements. One alternative embodiment of packed half 341 is one hundred twenty-eight bits long containing eight 16-bit data elements. One embodiment of packed single 342 is one hundred twenty-eight bits long and contains four 32-bit data elements. One embodiment of packed double 343 is one hundred twenty-eight bits long and contains two 64-bit data elements. It will be appreciated that such packed data formats may be further extended to other register lengths, for example, to 96-bits, 160-bits, 192-bits, 224-bits, 256-bits or more.

FIG. 3C illustrates various signed and unsigned packed data type representations in multimedia registers according to one embodiment of the present invention. Unsigned packed byte representation 344 illustrates the storage of an unsigned packed byte in a SIMD register. Information for each byte data element is stored in bit seven through bit zero for byte zero, bit fifteen through bit eight for byte one, bit twenty-three through bit sixteen for byte two, and finally bit one hundred twenty through bit one hundred twenty-seven for byte fifteen. Thus, all available bits are used in the register. This storage arrangement can increase the storage efficiency of the processor. As well, with sixteen data elements accessed, one operation can now be performed on sixteen data elements in a parallel fashion. Signed packed byte representation 345 illustrates the storage of a signed packed byte. Note that the eighth bit of every byte data element is the sign indicator. Unsigned packed word representation 346 illustrates how word seven through word zero are stored in a SIMD register. Signed packed word representation 347 is similar to the unsigned packed word in-register representation 346. Note that the sixteenth bit of each word data element is the sign indicator. Unsigned packed doubleword representation 348 shows how doubleword data elements are stored. Signed packed doubleword representation 349 is similar to unsigned packed doubleword in-register representation 348. Note that the necessary sign bit is the thirty-second bit of each doubleword data element.

FIG. 3D is a depiction of one embodiment of an operation encoding (opcode) format 360, having thirty-two or more bits, and register/memory operand addressing modes corresponding with a type of opcode format described in the “IA-32 Intel Architecture Software Developer's Manual Volume 2: Instruction Set Reference,” which is which is available from Intel Corporation, Santa Clara, Calif. on the world-wide-web (www) at intel.com/design/litcentr. In one embodiment, a dot-product operation may be encoded by one or more of fields 361 and 362. Up to two operand locations per instruction may be identified, including up to two source operand identifiers 364 and 365. For one embodiment of the dot-product instruction, destination operand identifier 366 is the same as source operand identifier 364, whereas in other embodiments they are different. For an alternative embodiment, destination operand identifier 366 is the same as source operand identifier 365, whereas in other embodiments they are different. In one embodiment of a dot-product instruction, one of the source operands identified by source operand identifiers 364 and 365 is overwritten by the results of the dot-product operations, whereas in other embodiments identifier 364 corresponds to a source register element and identifier 365 corresponds to a destination register element. For one embodiment of the dot-product instruction, operand identifiers 364 and 365 may be used to identify 32-bit or 64-bit source and destination operands.

FIG. 3E is a depiction of another alternative operation encoding (opcode) format 370, having forty or more bits. Opcode format 370 corresponds with opcode format 360 and comprises an optional prefix byte 378. The type of dot-product operation may be encoded by one or more of fields 378, 371, and 372. Up to two operand locations per instruction may be identified by source operand identifiers 374 and 375 and by prefix byte 378. For one embodiment of the dot-product instruction, prefix byte 378 may be used to identify 32-bit or 64-bit source and destination operands. For one embodiment of the dot-product instruction, destination operand identifier 376 is the same as source operand identifier 374, whereas in other embodiments they are different. For an alternative embodiment, destination operand identifier 376 is the same as source operand identifier 375, whereas in other embodiments they are different. In one embodiment, the dot-product operations multiply one of the operands identified by operand identifiers 374 and 375 to another operand identified by the operand identifiers 374 and 375 is overwritten by the results of the dot-product operations, whereas in other embodiments the dot-product of the operands identified by identifiers 374 and 375 are written to another data element in another register. Opcode formats 360 and 370 allow register to register, memory to register, register by memory, register by register, register by immediate, register to memory addressing specified in part by MOD fields 363 and 373 and by optional scale-index-base and displacement bytes.

Turning next to FIG. 3F, in some alternative embodiments, 64 bit single instruction multiple data (SIMD) arithmetic operations may be performed through a coprocessor data processing (CDP) instruction. Operation encoding (opcode) format 380 depicts one such CDP instruction having CDP opcode fields 382 and 389. The type of CDP instruction, for alternative embodiments of dot-product operations, may be encoded by one or more of fields 383, 384, 387, and 388. Up to three operand locations per instruction may be identified, including up to two source operand identifiers 385 and 390 and one destination operand identifier 386. One embodiment of the coprocessor can operate on 8, 16, 32, and 64 bit values. For one embodiment, the dot-product operation is performed on integer data elements. In some embodiments, a dot-product instruction may be executed conditionally, using selection field 381. For some dot-product instructions source data sizes may be encoded by field 383. In some embodiments of dot-product instruction, Zero (Z), negative (N), carry (C), and overflow (V) detection can be done on SIMD fields. For some instructions, the type of saturation may be encoded by field 384.

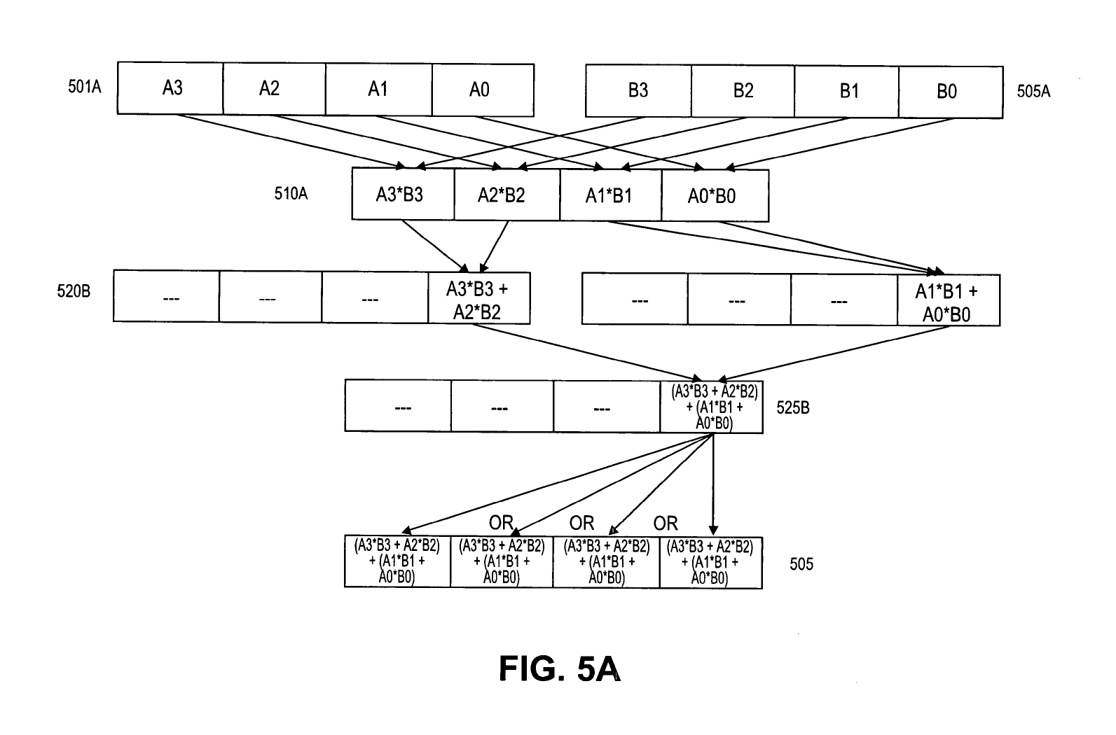

FIG. 4 is a block diagram of one embodiment of logic to perform a dot-product operation on packed data operands in accordance with the present invention. Embodiments of the present invention can be implemented to function with various types of operands such as those described above. For one implementation, dot-product operations in accordance to the present invention are implemented as a set of instructions to operate on specific data types. For instance, a dot-product packed single-precision (DPPS) instruction is provided to determine the dot-product for 32-bit data types, including integer and floating point. Similarly, a dot-product packed double-precision (DPPD) instruction is provided to determine the dot-product for 64-bit data types, including integer and floating point. Although these instructions have different names, the general dot-product operation that they perform is similar. For simplicity, the following discussions and examples below are in the context of a dot-product instruction to process data elements.

In one embodiment, the dot-product instruction identifies various information, including: an identifier of a first data operand DATA A 410 and an identifier of a second second data operand DATA B 420, and an identifier for the RESULTANT 440 of the dot-product operation (which may be the same identifier as one of the first data operand identifiers in one embodiment). For the following discussions, DATA A, DATA B, and RESULTANT are generally referred to as operands or data blocks, but not restricted as such, and also include registers, register files, and memory locations. In one embodiment, each dot-product instruction (DPPS, DPPD) is decoded into one micro-operation. In an alternative embodiment, each instruction may be decoded into a various number of micro-ops to perform the dot-product operation on the data operands. For this example, the operands 410, 420, are 128 bit wide pieces of information stored in a source register/memory having word wide data elements. In one embodiment, the operands 410, 420, are held in 128 bit long SIMD registers, such as 128 bit SSEx XMM registers. For one embodiment, the RESULTANT 440 is also a XMM data register. Furthermore, RESULTANT 440 may also be the same register or memory location as one of the source operands. Depending on the particular implementation, the operands and registers can be other lengths such as 32, 64, and 256 bits, and have byte, doubleword, or quadword sized data elements. Although the data elements of this example are word size, the same concept can be extended to byte and doubleword sized elements. In one embodiment, where the data operands are 64 bit wide, MMX registers are used in place of the XMM registers.

The first operand 410 in this example is comprised of a set of eight data elements: A3, A2, A1, and A0. Each individual data element corresponds to a data element position in the resultant 440. The second operand 420 is comprised of another set of eight data segments: B3, B2, B1, and B0. The data segments here are of equal length and each comprise of a single word (32 bits) of data. However, data elements and data element positions can possess other granularities other than words. If each data element was a byte (8 bits), doubleword (32 bits), or a quadword (64 bits), the 128 bit operands would have sixteen byte wide, four doubleword wide, or two quadword wide data elements, respectively. Embodiments of the present invention are not restricted to particular length data operands or data segments, and can be sized appropriately for each implementation.

The operands 410, 420, can reside either in a register or a memory location or a register file or a mix. The data operands 410, 420, are sent to the dot-product computation logic 430 of an execution unit in the processor along with a dot-product instruction. By the time the dot-product instruction reaches the execution unit, the instruction should have been decoded earlier in the processor pipeline, in one embodiment. Thus the dot-product instruction can be in the form of a micro operation (uop) or some other decoded format. For one embodiment, the two data operands 410, 420, are received at dot-product computation logic 430. The dot-product computation logic 430 generates a first multiplication product of two data elements of the first operand 410, with a second multiplication product of two data elements in the corresponding data element position of the second operand 420, and stores the sum of the first and second multiplication products into the appropriate position in the resultant 440, which may correspond to the same storage location as the first or second operand. In one embodiment, the data elements from the first and second operands are single precision (e.g., 32 bit), whereas in other embodiments, the data elements from the first and second operands are double precision (e.g., 64 bit).

For one embodiment, the data elements for all of the data positions are processed in parallel. In another embodiment, a certain portion of the data element positions can be processed together at a time. In one embodiment, the resultant 440 is comprised of two or four possible dot-product result positions, depending on whether DPPD or DPPS is performed, respectively: DOT-PRODUCT_{A31-0}, DOT-PRODUCT_{A63-32}, DOT-PRODUCT_{A95-64}, DOT-PRODUCT_{A127-96} (for DPPS instruction results), and DOT-PRODUCT_{A63-0}, DOT-PRODUCT_{A127-64} (for DPPD instruction results).

In one embodiment, the position of the dot-product result in resultant 440 depends upon a selection field associated with the dot-product instruction. For example, for DPPS instructions, the position of the dot-product result in the resultant 440 is DOT-PRODUCT_{A31-0}, if the selection field is equal to a first value, DOT-PRODUCT_{A63-32}, if the selection field is equal to a second value, DOT-PRODUCT_{A95-64}, if the selection field is equal to a third value, and DOT-PRODUCTA₁₂₇₋₆₄, if the selection field is equal to a fourth value. In the case of a DPPD instruction, the position of the dot-product result in resultant 440 is DOT-PRODUCT_{A63-0}, if the selection field is a first value, and DOT-PRODUCT_{A127-64} if the selection field is a second value.

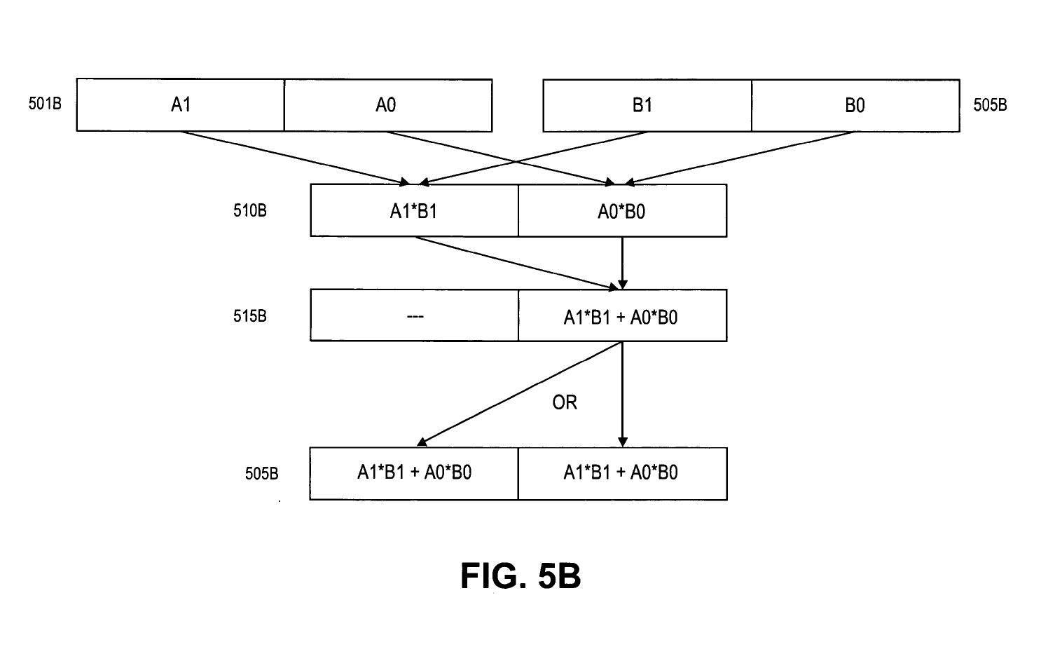

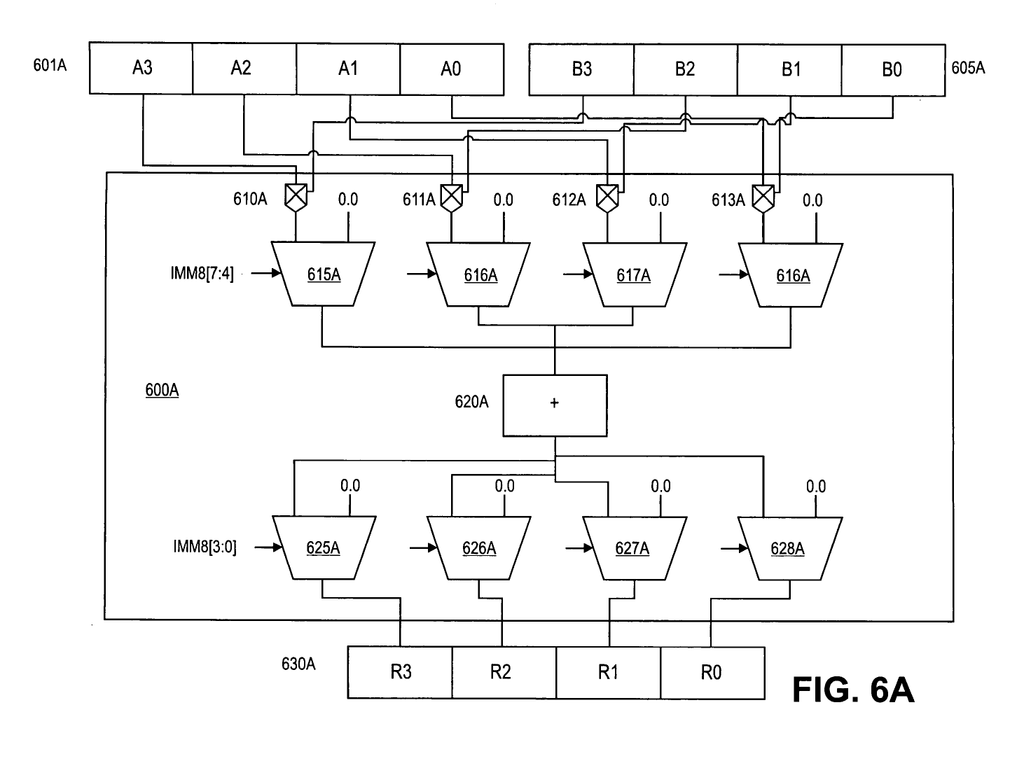

FIG. 5a illustrates the operation of a dot-product instruction according to one embodiment of the present invention. Specifically, FIG. 5a illustrates the operation of a DPPS instruction, according to one embodiment. In one embodiment, the dot-product operation of the example illustrated in FIG. 5a may substantially be performed by the dot-product computation logic 430 of FIG. 4. In other embodiments, the dot-product operation of FIG. 5a may be performed by other logic, including hardware, software, or some combination thereof.

In other embodiments, the operations illustrated in FIGS. 4, 5a, and 5b may be performed in any combination or order to produce the dot-product result. In one embodiment, FIG. 5a illustrates a 128-bit source register 501a including storage locations to up to store four single precision floating point or integer values of 32 bits each, A0-A3. Similarly illustrated in FIG. 5a is a 128-bit destination register 505a including storage locations to store up to four single precision floating point or integer values of 32 bits each, B0-B3. In one embodiment, each value, A0-A3, stored in the source register is multiplied to a corresponding value, B0-B3, stored in the corresponding position of the destination register and each resultant value, A0*B0, A1*B1, A2*B2, A3*B3 (referred to herein as the “products”), is stored in a corresponding storage location of a first 128-bit temporary register (“TEMP1”) 510a including storage locations to store up to four single precision floating point or integer values of 32 bits each.

In one embodiment, pairs of products are added together and each sum (referred to herein as “the intermediate sums”) is stored into a storage location of a second 128-bit temporary register (“TEMP2”) 515a and a third 128-bit temporary register (“TEMP3”) 520a. In one embodiment the products are stored into the least-most significant 32-bit element storage location of the first and second temporary registers. In other embodiments, they may be stored in other element storage locations of the first and second temporary registers. Furthermore, in some embodiments, the products may be stored in the same register, such as either the first or second temporary register.

In one embodiment, the intermediate sums are added together (referred to herein as “the final sum”) and stored into storage element a fourth 128-bit temporary register (“TEMP4”) 525a. In one embodiment, the final sum is stored into a least-significant 32-bit storage element of the TEMP4, whereas in other embodiments the final sum is stored into other storage elements of TEMP4. The final sum is then stored into a storage element of the destination register 505a. The exact storage element into which the final sum is to be stored may depend on variables configurable within the dot-product instruction. In one embodiment, an immediate field (“IMMy[x]”) containing a number of bit storage locations may be used to determine the destination register storage element into which the final sum is to be stored. For example, in one embodiment, if the IMM8[0] field contains a first value (e.g., “1”), the final sum is stored into storage element B0 of the destination register, if the IMM8[1] field contains a first value (e.g., “1”), the final sum is stored into storage element B1, if the IMM8[2] field contains a first value (e.g., “1”), the final sum is stored into storage element B2 of the destination register, and if the IMM8[3] field contains a first value (e.g., “1”), the final sum is stored into storage element B3 of the destination register. In other embodiments, other immediate fields may be used to determine the storage element into which the final sum is stored in the destination register.

In one embodiment, immediate fields may be used to control whether each multiply and addition operation is performed in the operation illustrated in FIG. 5a. For example, IMM8[4] may be used to indicate (by being set to a “0” or “1”, for example) whether the A0 is to be multiplied by B0 and the result stored into TEMP1. Similarly, IMM8[5] may be used to indicate (by being set to a “0” or “1”, for example) whether the A1 is to be multiplied by B1 and the result stored into TEMP1 Likewise, IMM8[6] may be used to indicate (by being set to a “0” or “1”, for example) whether the A2 is to be multiplied by B2 and the result stored into TEMP1. Finally, IMM8[7] may be used to indicate (by being set to a “0” or “1”, for example) whether the A3 is to be multiplied by B3 and the result stored into TEMP1.

FIG. 5b illustrates the operation of a DPPD instruction, according to one embodiment. One difference between the DPPS and DPPD instructions is that DPPD operate on double precision floating point and integer values (e.g., 64 bit values) instead of single precision values. Accordingly, there are fewer data elements to manage and therefore fewer intermediate operations and storage units (e.g., registers) involved in performing a DPPD instruction than a DPPS instruction, in one embodiment.

In one embodiment, FIG. 5b illustrates a 128-bit source register 501b including storage elements to up to store two double precision floating point or integer values of 64 bits each, A0-A1. Similarly illustrated in FIG. 5b is a 128-bit destination register 505b including storage elements to store up to two double precision floating point or integer values of 64 bits each, B0-B1. In one embodiment, each value, A0-A1, stored in the source register is multiplied to a corresponding value, B0-B1, stored in the corresponding position of the destination register and each resultant value, A0*B0, A1*B1 (referred to herein as the “products”), is stored in a corresponding storage element of a first 128-bit temporary register (“TEMP1”) 510b including storage elements to store up to two double precision floating point or integer values of 64 bits each.

In one embodiment, pairs of products are added together and each sum (referred to herein as “the final sum”) is stored into a storage element of a second 128-bit temporary register (“TEMP2”) 515b. In one embodiment the products and final sum are stored into the least-most significant 64-bit element storage location of the first and second temporary registers, respectively. In other embodiments, they may be stored in other element storage locations of the first and second temporary registers.

In one embodiment, the final sum is stored into a storage element of the destination register 505b. The exact storage element into which the final sum is to be stored may depend on variables configurable within the dot-product instruction. In one embodiment, an immediate field (“IMMy[x]”) containing a number of bit storage locations may be used to determine the destination register storage element into which the final sum is to be stored. For example, in one embodiment, if the IMM8[0] field contains a first value (e.g., “1”), the final sum is stored into storage element B0 of the destination register, if the IMM8[1] field contains a first value (e.g., “1”), the final sum is stored into storage element B 1. In other embodiments, other immediate fields may be used to determine the storage element into which the final sum is stored in the destination register.

In one embodiment, immediate fields may be used to control whether each multiply operation is performed in the dot-product operations illustrated in FIG. 5b. For example, IMM8[4] may be used to indicate (by being set to a “0” or “1”, for example) whether the A0 is to be multiplied by B0 and the result stored into TEMP1. Similarly, IMM8[5] may be used to indicate (by being set to a “0” or “1”, for example) whether the A1 is to be multiplied by B1 and the result stored into TEMP1. In other embodiments, other control techniques for determining whether to perform the multiply operations of the dot-product may be used.

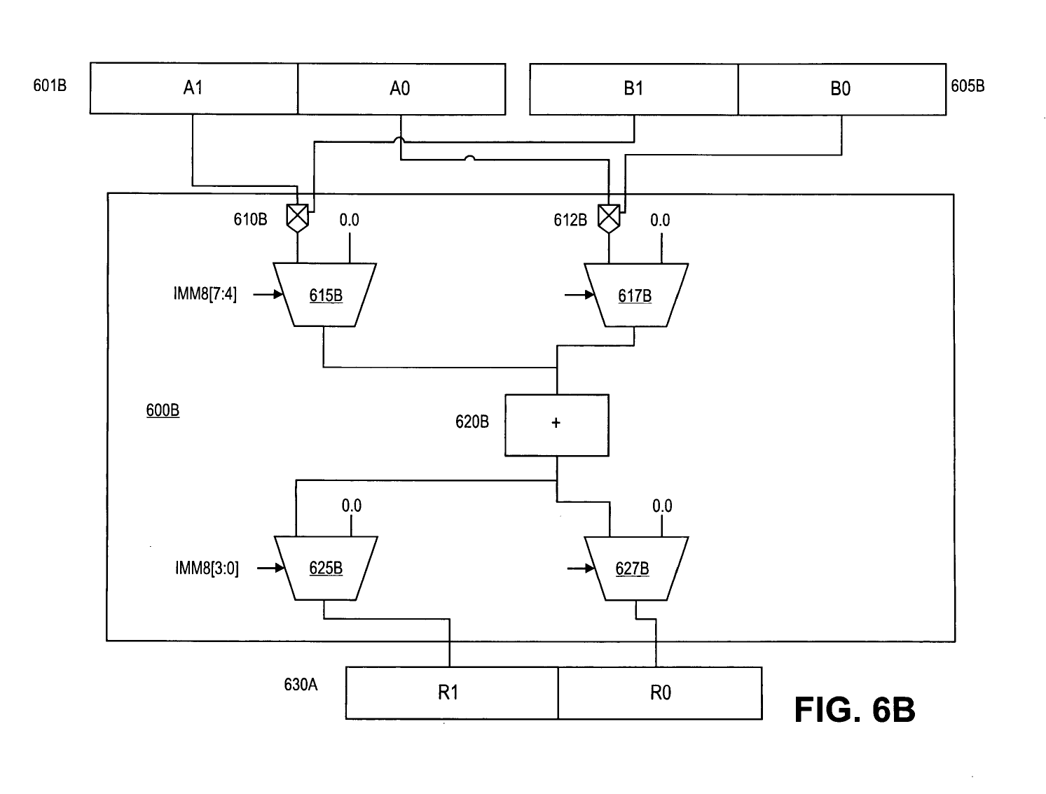

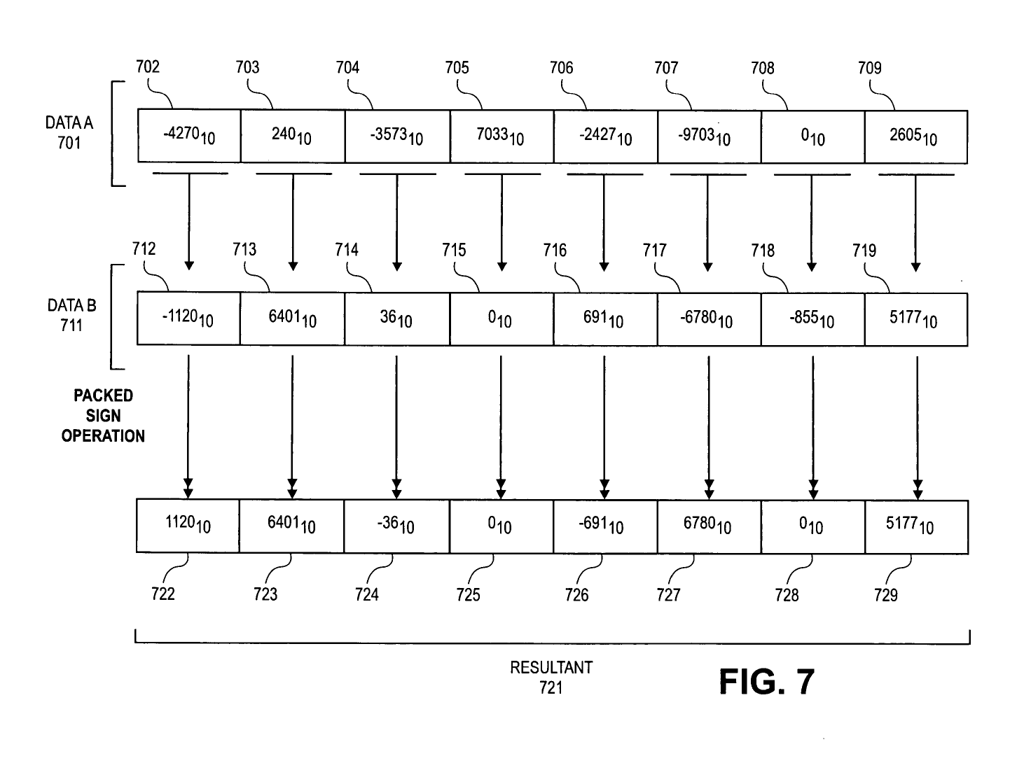

FIG. 6A is a block diagram of a circuit 600a for performing a dot-product operation on single-precision integer or floating point values in accordance with one embodiment. The circuit 600a of this embodiment multiplies, via multipliers 610a-613a, corresponding single-precision elements of two registers 601a and 605a, the results of which may be selected by multiplexers 615a-618a using an immediate field, IMM8[7:4]. Alternatively, multiplexers 615a-618a may select a zero value instead of the corresponding product of the multiplication operation for each element. The result of the selection by multiplexers 615a-618a are then added together by adder 620a, and the result is stored in any of the elements of result register 630a, depending upon the value of immediate field, IMM8[3:0], which selects a corresponding sum result from adder 620a using multiplexers 625a-628a. In one embodiment, multiplexers 625a-628a may select zeros to fill an element of result register 630a if a sum result is not chosen to be stored stored in the result element. In other embodiments, more adders may be used to generate the sums of the various multiplication products. Furthermore, in some embodiments, intermediate storage elements may be used to store the product or sum results until they are further operated upon.

FIG. 6B is a block diagram of a circuit 600b for performing a dot-product operation on single-precision integer or floating point values in accordance with one embodiment. The circuit 600b of this embodiment multiplies, via multipliers 610b, 612b, corresponding single-precision elements of two registers 601b and 605b, the results of which may be selected by multiplexers 615b, 617b using an immediate field, IMM8[7:4]. Alternatively, multiplexers 615b, 618b may select a zero value instead of the corresponding product of the multiplication operation for each element. The result of the selection by multiplexers 615b, 618b are then added together by adder 620b, and the result is stored in any of the elements of result register 630b, depending upon the value of immediate field, IMM8[3:0], which selects a corresponding sum result from adder 620b using multiplexers 625b, 627b. In one embodiment, multiplexers 625b-627b may select zeros to fill an element of result register 630b if a sum result is not chosen to be stored stored in the result element. In other embodiments, more adders may be used to generate the sums of the various multiplication products. Furthermore, in some embodiments, intermediate storage elements may be used to store the product or sum results until they are further operated upon.

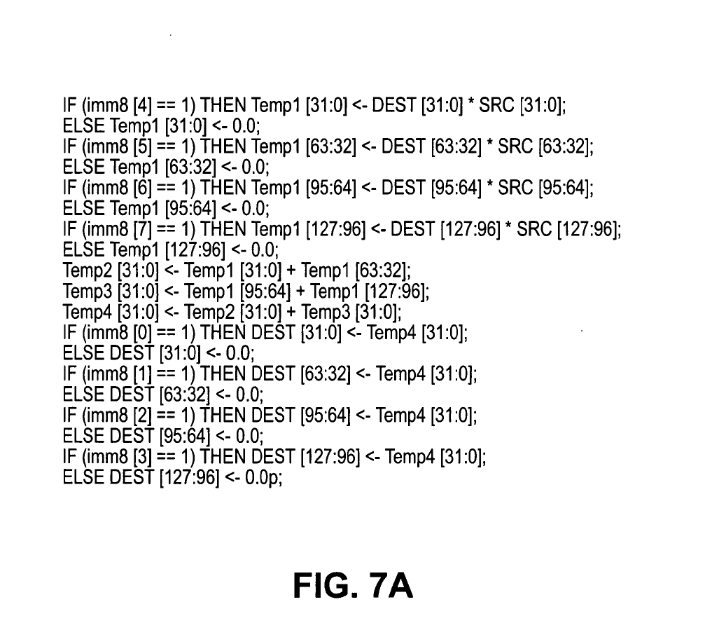

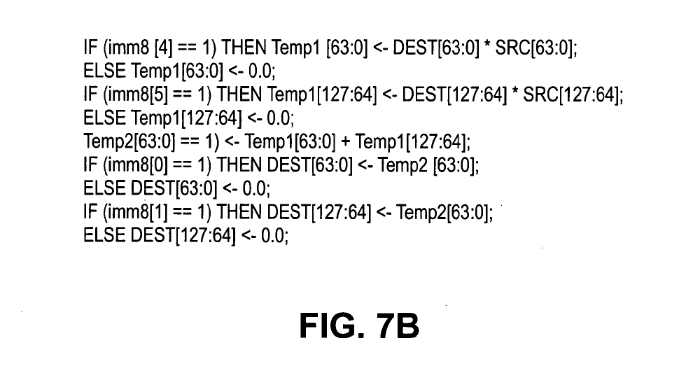

FIG. 7A is a pseudo-code representation of operations to perform a DPPS instruction, according to one embodiment. The pseudo-code illustrated in FIG. 7A indicates that a single-precision floating point or integer value stored in a source register (“SRC”) in bits 31-0 is to be multiplied to a single-precision floating point or integer value stored in a destination register (“DEST”) in bits 31-0 and the result stored in bits 31-0 of a temporary register (“TEMP1”) only if an immediate value stored in an immediate field (“IMM8[4]”) is equal to “1”. Otherwise, bit storage locations 31-0 may contain a null value, such as all zeros.

Also illustrated in FIG. 7A is pseudo-code to indicate that a single-precision floating point or integer value stored in the SRC register in bits 63-32 is to be multiplied to a single-precision floating point or integer value stored in the DEST register in bits 63-32 and the result stored in bits 63-32 of a TEMP1 register only if an immediate value stored in an immediate field (“IMM8[5]”) is equal to “1”. Otherwise, bit storage locations 63-32 may contain a null value, such as all zeros.

Similarly illustrated in FIG. 7A is pseudo-code to indicate that a single-precision floating point or integer value stored in the SRC register in bits 95-64 is to be multiplied to a single-precision floating point or integer value stored in the DEST register in bits 95-64 and the result stored in bits 95-64 of a TEMP1 register only if an immediate value stored in an immediate field (“IMM8[6]”) is equal to “1”. Otherwise, bit storage locations 95-64 may contain a null value, such as all zeros.

Finally, illustrated in FIG. 7A is pseudo-code to indicate that a single-precision floating point or integer value stored in the SRC register in bits 127-96 is to be multiplied to a single-precision floating point or integer value stored in the DEST register in bits 127-96 and the result stored in bits 127-96 of a TEMP1 register only if an immediate value stored in an immediate field (“IMM8[7]”) is equal to “1”. Otherwise, bit storage locations 127-96 may contain a null value, such as all zeros.

Next, FIG. 7A illustrates that bits 31-0 are added to bits 63-32 of TEMP1 and the result stored into bit storage 31-0 of a second temporary register (“TEMP2”). Similarly, bits 95-64 are added to bits 127-96 of TEMP1 and the result stored into bit storage 31-0 of a third temporary register (“TEMP3”). Finally, bits 31-0 of TEMP2 are added to bits 31-0 of TEMP3 and the result stored into bit storage 31-0 of a fourth temporary register (“TEMP4”).

The data stored in temporary registers may then be stored into the DEST register, in one embodiment. The particular location within the DEST register to store the data may depend upon other fields within the DPPS instruction, such as fields in IMM8[x]. Particularly, FIG. 7A illustrates that, in one embodiment, bits 31-0 of TEMP4 are stored into DEST bit storage 31-0 if IMM8[0] is equal to “1”, DEST bit storage 63-32 if IMM8[1] is equal to “1”, DEST bit storage 95-64 if IMM8[2] is equal to “1”, or DEST bit storage 127-96 if IMM8[3] is equal to “1”. Otherwise, the corresponding DEST bit element will contain a null value, such as all zeros.

FIG. 7B is a pseudo-code representation of operations to perform a DPPD instruction, according to one embodiment. The pseudo-code illustrated in FIG. 7B indicates that a single-precision floating point or integer value stored in a source register (“SRC”) in bits 63-0 is to be multiplied to a single-precision floating point or integer value stored in a destination register (“DEST”) in bits 63-0 and the result stored in bits 63-0 of a temporary register (“TEMP1”) only if an immediate value stored in an immediate field (“IMM8[4]”) is equal to “1”. Otherwise, bit storage locations 63-0 may contain a null value, such as all zeros.

Also illustrated in FIG. 7B is pseudo-code to indicate that a single-precision floating point or integer value stored in the SRC register in bits 127-64 is to be multiplied to a single-precision floating point or integer value stored in the DEST register in bits 127-64 and the result stored in bits 127-64 of a TEMP1 register only if an immediate value stored in an immediate field (“IMM8[5]”) is equal to “1”. Otherwise, bit storage locations 127-64 may contain a null value, such as all zeros.

Next, FIG. 7B illustrates that bits 63-0 are added to bits 127-64 of TEMP1 and the result stored into bit storage 63-0 of a second temporary register (“TEMP2”). The data stored in the temporary register may then be stored into the DEST register, in one embodiment. The particular location within the DEST register to store the data may depend upon other fields within the DPPS instruction, such as fields in IIVIM8[x]. Particularly, FIG. 7A illustrates that, in one embodiment, bits 63-0 of TEMP2 are stored into DEST bit storage 63-0 if IMM8[0] is equal to “1”, or bits 63-0 of TEMP2 are stored in DEST bit storage 127-64 if IMM8[1] is equal to “1”. Otherwise, the corresponding DEST bit element will contain a null value, such as all zeros.

The operations disclosed in FIGS. 7A and 7B are merely one representation of operations that may be used in one or more embodiments of the invention. Specifically, the pseudo-code illustrated in FIGS. 7A and 7B correspond to operations performed according to one or more processor architectures having 128 bit registers. Other embodiments may be performed in processor architectures having any size of registers, or other type of storage area. Furthermore, other embodiments may not use the registers exactly as illustrated in FIGS. 7A and 7B. For example, in some embodiments, a different number of temporary registers, or none at all, may be used to stored operands. Lastly, embodiments of the invention may be performed among numerous processors or processing cores using any number of registers or datatypes.

Thus, techniques for performing a dot-product operation are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor comprising:
an instruction prefetcher to fetch a dot-product packed single-precision (DPPS) floating point instruction having a first operand, a second operand and a 8-bit immediate operand;
a first 128-bit XMM register to store the first operand;
a second 128-bit XMM register to store the second operand;
a decoder to decode the DPPS floating point instruction fetched by the instruction prefetcher;
a scheduler to schedule the DPPS floating point instruction; and
an execution unit to perform a dot-product operation on the first operand and the second operand based on the scheduled DPPS floating point instruction, wherein each operand has four corresponding 32-bit segments, each corresponding 32-bit segment is to store a corresponding packed single-precision floating point value, wherein each respective bit 7, bit 6, bit 5, and bit 4 of the 8-bit immediate operand is to select a respective product of the corresponding packed single-precision floating point values for inclusion in the dot-product operation to generate a dot-product result, and wherein the dot-product result is to be stored in the first 128-bit XMM register.

2. The processor of claim 1, wherein the storage of the dot-product result in the first 128-bit XMM register is to be selected according to bit 3, bit 2, bit 1 and bit 0 of the 8-bit immediate operand.

3. A system on a chip (SOC) comprising:
a memory controller;
a display controller; and
a processor coupled to the memory controller and the display controller, the processor comprising:
an instruction prefetcher to fetch a dot-product packed single-precision (DPPS) floating point instruction having a first operand, a second operand and a 8-bit immediate operand;
a first 128-bit XMM register to store the first operand;
a second 128-bit XMM register to store the second operand;
a decoder to decode the DPPS floating point instruction fetched by the instruction prefetcher;
a scheduler to schedule the DPPS floating point instruction; and
an execution unit to perform a dot-product operation on the first operand and the second operand based on the scheduled DPPS floating point instruction, wherein each operand has four corresponding 32-bit segments, each corresponding 32-bit segment is to store a corresponding packed single-precision floating point value, wherein each respective bit 7, bit 6, bit 5, and bit 4 of the 8-bit immediate operand is to select a respective product of the corresponding packed single-precision floating point values for inclusion in the dot-product operation to generate a dot-product result, and wherein the dot-product result is to be stored in the first 128-bit XMM register.

4. The SOC of claim 3, wherein the storage of the dot-product result in the first 128-bit XMM register is to be selected according to bit 3, bit 2, bit 1 and bit 0 of the 8-bit immediate operand.

5. The SOC of claim 3, further comprising interface logic coupled to the processor, the interface logic including universal serial bus (USB) interface logic and input/output (I/O) interface logic.

6. A system comprising:
a processor comprising:
an instruction prefetcher to fetch a dot-product packed single-precision (DPPS) floating point instruction having a first operand, a second operand and a 8-bit immediate operand;
a first 128-bit XMM register to store the first operand;
a second 128-bit XMM register to store the second operand;
a decoder to decode the DPPS floating point instruction fetched by the instruction prefetcher;
a scheduler to schedule the DPPS floating point instruction; and
an execution unit to perform a dot-product operation on the first operand and the second operand based on the scheduled DPPS floating point instruction, wherein each operand has four corresponding 32-bit segments, each corresponding 32-bit segment is to store a corresponding packed single-precision floating point value, wherein each respective bit 7, bit 6, bit 5, and bit 4 of the 8-bit immediate operand is to select a respective product of the corresponding packed single-precision floating point values for inclusion in the dot-product operation to generate a dot-product result, and wherein the dot-product result is to be stored in the first 128-bit XMM register;
a network controller;
an input/output (I/O) controller coupled with the processor;
a hard disk drive coupled with the I/O bridge;
a flash memory coupled with the I/O bridge; and
a wireless transceiver.

7. The system of claim 6, wherein the storage of the dot-product result in the first 128-bit XMM register is to be selected according to bit 3, bit 2, bit 1 and bit 0 of the 8-bit immediate operand.

8. A system comprising:
a processor comprising:
an instruction prefetcher to fetch a dot-product packed single-precision (DPPS) floating point instruction having a first operand, a second operand and a 8-bit immediate operand;
a first 128-bit XMM register to store the first operand;
a second 128-bit XMM register to store the second operand;
a decoder to decode the DPPS floating point instruction fetched by the instruction prefetcher;
a scheduler to schedule the DPPS floating point instruction; and
an execution unit to perform a dot-product operation on the first operand and the second operand based on the scheduled DPPS floating point instruction, wherein each operand has four corresponding 32-bit segments, each corresponding 32-bit segment is to store a corresponding packed single-precision floating point value, wherein each respective bit 7, bit 6, bit 5, and bit 4 of the 8-bit immediate operand is to select a respective product of the corresponding packed single-precision floating point values for inclusion in the dot-product operation to generate a dot-product result, and wherein the dot-product result is to be stored in the first 128-bit XMM register;
a memory controller coupled with the processor;
a memory coupled with the memory controller;
an input/output (I/O) controller coupled with the memory controller;
a mass storage device;
a wireless transceiver; and
an audio controller.

9. The system of claim 8, wherein the storage of the dot-product result in the first 128-bit XMM register is to be selected according to bit 3, bit 2, bit 1 and bit 0 of the 8-bit immediate operand.

10. The system of claim 8, wherein the mass storage device is a hard disk drive.

11. The system of claim 8, wherein the mass storage device is a flash memory device.
